(19) United States
(12) Patent Application Publication
(10) Pub. No.: US 2008/0151696 A1
(43) Pub. Date: Jun. 26, 2008

(54) Multimedia Computerised Radio Alarm System

(76) Inventors: Olivier Giroud, Neuilly Sur Seine (FR); Thomas Serval, Neuilly Sur Seine (FR)

Correspondence Address: YOUNG & THOMPSON, 209 Madison Street, Suite 500, ALEXANDRIA, VA, 22314, US

(21) Appl. No.: 11/815,687

(22) PCT Filed: Feb. 8, 2006
(86) PCT No.: PCT/FR2006/050108

§ 371 Date: Sep. 19, 2007

(30) Foreign Application Priority Data
Feb. 8, 2005 (FR) 0550370

(51) Int. Cl. G04G 13/02; G04B 47/00

(52) U.S. Cl. 368/10; 368/73

(57) ABSTRACT

The present invention relates to a computer multimedia radio alarm-clock system with a communication link between on the one hand a radio alarm-clock device (1) and on the other hand a distinct computer programming device (2) characterised in that it comprises a short distance bi-directional local communication link (3,8) enabling to make the multimedia radio alarm-clock device and the computer programming device communicate with one another, wherein the multimedia radio alarm-clock device includes user-controlled restitution and selection interfaces, local communication link interfaces “WIFI”® or ‘WIMAX’®, and by mains carrier currents, a USB® interface, means enabling reception, storage and reproduction, continuously or not, of multimedia messages, in particular sound and/or texts and/or images and/or video data, means enabling setting up the operation of said alarm-clock either directly, or by receiving configuration data, or by unloading on the USB® interface, and in that the system includes means enabling to perform in the computer programming device tasks in relation with the activity of the alarm-clock.

The present invention relates to a computer multimedia radio alarm-clock system which includes radio communications means or communications means with data carrier currents as well as means of configuration, transmission, memorisation and restitution, continuously or not, of sounds and/or images and more generally multimedia data.

An increasing number of electronic devices include short-range communication means for linking with computer equipment. Among these means of communication we are dealing more particularly with the short-range local ones (approximately less than some hundred meters according to the standard), for wireless transmissions such as in particular “BLUETOOTH”®, “WIFI”®, “ZIGBEE”®, EDR, “WIMAX”®, 802.11n, UWB, and for network transmissions those of the carrier current type over an electric power supply line. These radiocommunication means provide bidirectional data links up to some hundred meters. Among such devices one can mention mobile telephones, in particular GSM, GPRS, CDMA, EDGE, UMTS, personal computers (PC) or portable digital assistants (PDA) which include such means, in particular “BLUETOOTH”®. Besides, certain terminal or intermediate data network equipment may include such means, in particular “BLUETOOTH”® or ‘WIFI® such as for example terminal residential boxes of telephone or data cables of “FREEBOX”® or “LIVEBOX”® gateway type.

Most of these devices or equipment enables the transfer of data and in particular sound signals (mobile telephones, telephone cables, data cables).

A “BLUETOOTH”® radiocommunication module is also known which enables to add communication functionalities and computer applications to various electronic products. The SMARTMODULE from BARACODA company may thus be mentioned which was the object of a patent application WO-02/082316.

We also know multimedia devices which includes programmable computer means in particular for managing the functionalities of an alarm-clock as well as for storing, reproducing sounds and/or images as for example the patent U.S. Pat. No. 6,678,215.

The invention, for its own part, relates to a computer multimedia radio alarm-clock system with a communication link between on the one hand a radio alarm-clock device and on the other hand a distinct computer programming device.

According to the invention, the system comprises a short distance bi-directional local communication link, enabling to make the multimedia radio alarm-clock device and the computer programming device communicate with one another, wherein the multimedia radio alarm-clock device includes:

a reproduction interface, at least visual and acoustic,

an input interface of at least user selections,

a local communication link interface “WIFI”® or ‘WIMAX’®,

a local communication link interface by mains carrier currents,

a USB® interface,

means enabling reception, storage and reproduction, continuously or not, of multimedia messages, in particular sound and/or texts and/or images and/or video data,

means enabling to set up the operation of said alarm-clock either directly by inputting configuration data via the input interface of said alarm-clock, or by receiving configuration data via the local communication link, or by unloading onto the USB® interface configuration data from a USB® compatible memory, and the system includes means enabling to perform in the computer programming device tasks in relation with the activity of the alarm-clock.

The expression multimedia alarm-clock radio corresponds to a device which triggers an action in relation to a current time with respect to a programmed action triggering time, the action being the emission of a sound (as the case may be: sound, music, voice . . . ) and/or the display of information (as the case may be: texts, images, video . . . ), the electric switching of an apparatus to which it is connected . . .

In various embodiments of the invention, the following means used individually or in combination in all the technically viable possibilities, are employed:

the multimedia radio alarm-clock device includes moreover a sound input and acquisition interface for voice selections by a user, and the sounds once acquired are transmitted to the computer programming device for performing a voice recognition task of selections,

the selections are performed from menus and the menus are arranged in a level-based tree-structure, wherein the menus are stored in the computer programming device, and the system includes means so that during the selections in the multimedia radio alarm-clock device, the current level of the selection Ni and the level immediately following Ni+1 of the hierarchy of the menu are stored in the multimedia radio alarm-clock device,

the system includes means for storing in the multimedia radio alarm-clock device moreover the level immediately preceding Ni−1 of the current level Ni of the hierarchy of the menu,

the computer programming device is distant and is on a web network and it includes a communication application with the alarm-clock device via a gateway, a web communication interface enables to perform a console application of an alarm-clock configuration website.

the multimedia radio alarm-clock device includes moreover an RS232 interface,

the multimedia radio alarm-clock device includes moreover a ‘BLUETOOTH’® local communication link interface,

the ‘BLUETOOTH’® local communication link interface is transferred to a ‘BLUETOOTH’® interface dongle connected to the USB® or RS232 interface of the multimedia radio alarm-clock device.

the system comprises means enabling to know the multimedia data reproduced by the multimedia radio alarm-clock device, wherein one of the means is the transmission from the multimedia alarm-clock radio device towards the computer programming device of a portion of the data reproduced and comparison in said computer programming device with a reproducible database,

the communication link is a radiofrequency link, in particular “BLUETOOTH”® or “WIFI”®,

the communication link interface is a link with mains carrier currents,

the communication link is a series wire link in particular RS232 or USB,

the communication link is a series wire link, wherein the multimedia radio alarm-clock device and the computer programming device form a single assembly,

the multimedia messages include sounds,

the multimedia messages include images,

the multimedia messages include moreover sounds,

the multimedia messages include moreover images,

the computer programming device includes software and user interface means enabling the configuration of the operation of said multimedia radio alarm-clock by inputting configuration data from of said computer programming device and the transmission thereof to the multimedia radio alarm-clock device via the communication link,

inputting configuration data from of said computer programming device is performed locally, independent of any connection to any communication network,

inputting configuration data from of said computer programming device is performed remotely via a data communication network,

the computer programming device includes moreover a web interface enabling the configuration of the operation of said multimedia radio alarm-clock via a web site,

the computer programming device includes a communication application with the multimedia radio alarm-clock device, wherein a web communication interface enables to perform a console application of an alarm-clock configuration website of the multimedia radio alarm-clock,

the computer programming device includes software and user interface means enabling the configuration of the operation of said multimedia radio alarm-clock by inputting configuration data from a remote website and the transmission thereof to the multimedia radio alarm-clock device via a communication link, wherein the computer programming device is a residential gateway,

the configuration data include at least one multimedia data file,

the configuration data include time synchronisation data,

the multimedia data files are encoded sounds in a format enabling compression of data and in particular in MP3 format or the like,

the multimedia data files are images (fixed or animated=video: <<SKIN>>) encoded in a format enabling compression of data and in particular in JPEG format or the like,

the multimedia data files are SMS, MMS type texts or the like,

the multimedia data files are encoded texts in particular in HTML format, XTML format or others,

the multimedia data files are encoded texts in a format enabling compression of data and in particular in HTML or XTML compressed format,

the multimedia radio alarm-clock device includes a series type bidirectional data link interface, in particular RS232 or USB, connected to an external (dongle) or internal radiocommunication module and in particular ‘BLUETOOTH’® or others,

the multimedia radio alarm-clock device includes a series type bidirectional data link interface, in particular RS232 or USB, connected to a ‘BLUETOOTH’® interface dongle,

the multimedia radio alarm-clock device includes a digital display,

the multimedia radio alarm-clock device includes an alphanumeric display,

the multimedia radio alarm-clock device includes a graphic display,

the multimedia radio alarm-clock device includes a liquid crystals type display,

the multimedia radio alarm-clock device includes means enabling sound restitution in mono,

the multimedia radio alarm-clock device includes means enabling sound restitution in stereo,

the computer programming device includes a series type bidirectional data link interface, in particular RS232 or USB, connected to an external (dongle) or internal radiocommunication module and in particular ‘BLUETOOTH’® or others,

the computer programming device includes a series type bidirectional data link interface, in particular RS232 or USB, connected to a ‘BLUETOOTH’® interface dongle,

the computer programming device is a PC type personal computer (personal computer) or personal assistant (PDA) or, still, a mobile phone or a multimedia router type (gateway) wireless residential platform (for instance “LIVEBOX”®),

the computer programming device is a remote computer (server), a multimedia router type (gateway) wireless local residential platform (for instance “LIVEBOX”®) being implemented,

the multimedia radio alarm-clock device includes a display enabling, in addition to time display, at least the display of messages, (with or without sound, in the latter case a simple “buzzer” or the like is implemented preferably)

the multimedia radio alarm-clock device includes a display enabling only to display time, (with or without sound, in the latter case a simple “buzzer” or the like is implemented preferably)

the multimedia radio alarm-clock device includes means enabling the restitution of sound data,

for reproducing a multimedia message, a file is downloaded in a buffer-memory of the multimedia alarm-clock radio device, the restitution starting when a filling threshold of the buffer-memory has been reached, and the system includes means enabling to modify the threshold in relation to criteria, said criteria being selected among one or several of the following criteria:
duration of the latent time before the beginning of the restitution, wherein the reduction of said latent time is obtained by reducing the threshold,
quality of the download in terms of passband, wherein a high passband causes reduction of the threshold,

the multimedia radio alarm-clock device is arranged in a box comprising a mains supply backed up by a stand-alone power supply source such as a standard battery or a battery rechargeable by said mains supply,

the multimedia radio alarm-clock device includes moreover a means for controlling a switching output of an electric power supply for an electric device by a power switching means arranged in the alarm-clock and enabling turning said apparatus on and off,

the switching means is selected among: an electromagnetic relay, a static relay, a triac, a power transistor,

the electrical apparatus is external to the multimedia radio alarm-clock device,

the multimedia radio alarm-clock device is arranged in the electric apparatus and the power switching control enables to turn said apparatus on and off,

the electric apparatus is in particular a HIFI set or a coffee-machine.

The invention also relates to a multimedia radio alarm-clock device especially adapted for the system according to one several of the previous features.

This invention will now be exemplified without being limited thereto with the following description in relation with:

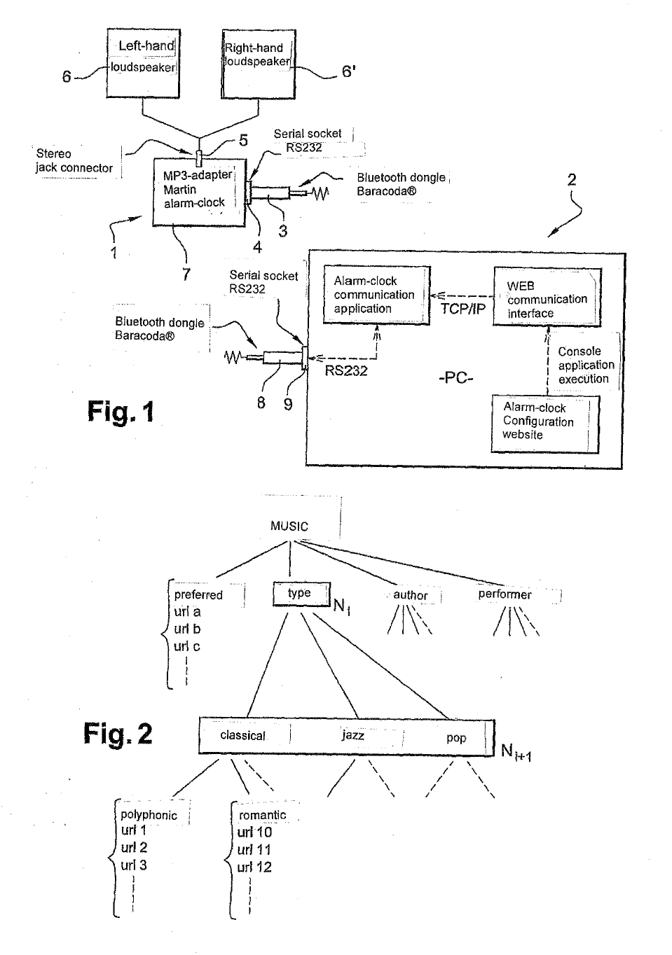

FIG. 1 which represents diagrammatically a simplified multimedia radio alarm-clock system,

FIG. 2 which represents diagrammatically an example of menu tree-structure with the current selection level Ni in the multimedia radio alarm-clock and the selection level placed in cache memory Nᵢ₊₁ in said multimedia radio alarm-clock.

The system represented on FIG. 1 includes a multimedia radio alarm-clock device 1 and an external programming computer device 2 (PC type computer or assistant, mobile telephone, gateway toward another computer exhibiting the programming functionalities of the system). The term programming relates as well to the configuration of the multimedia radio alarm-clock device (setting the time, incorporation into a network: inputting a communication encryption code or others), as the operation thereof (selection of multimedia content, sound broadcast, restitution of images, capture of sounds or the like).

The multimedia radio alarm-clock device (called indifferently alarm-clock or alarm-clock device below) includes a computer module 7 (multimedia computer module with processor, memory, user and communication interfaces) adapted to MP3 (or other types of files) and to <<STREAMING>>) or broadcast (for continuous restitution of multimedia formats, sounds and/or images such web radio station or television) with audio interface 5, for instance by stereo connector towards two external loudspeakers 6 and 6′ (according to a variation, the loudspeakers are incorporated to the alarm-clock), a radio interface such as “WIFI”® and/or “WIMAX”® (not represented on FIG. 1) and, preferably, a “BLUETOOTH”® interface.

The alarm-clock device 1 is powered by a mains supply which is backed up in case of mains power cut by an electrochemical power supply such as a standard battery or a rechargeable battery. In the case of a rechargeable battery, the latter is preferably recharged by the mains power supply when the mains voltage is available.

Thus, the alarm-clock includes an integrated “WIFI”® and/or “WIMAX”® radiocommunication interface. It may also include a communication interface based on a mains carrier current (not represented on FIG. 1) since it may be connected to the mains for its electric power supply. Conversely on FIG. 1, a data link interface has been represented moreover with a serial connector 4 RS232 connected to a communication dongle (module) 3 “BLUETOOTH”® (“BLUETOOTH”® <<dongle> from BARACODA company). According to a variation, this “BLUETOOTH”® radiocommunication interface is integrated in the alarm-clock. The “BLUETOOTH”® interface enables to make the alarm-clock communicate with any other type of equipment having the same type of “BLUETOOTH”® radiocommunication means and, for instance, one/other alarm-clocks, a mobile phone or the like. In the case of communication with a mobile phone, the system includes means enabling to transfer a sound file, in particular dialling tone or music, downloaded onto the telephone from the telephone network towards the alarm-clock where it can be used. The same goes for image files (screen background, graphics: exchange rate, stock exchange rates . . . ) downloaded on the telephone and then sent to the display of the alarm-clock. It should be understood that it is also possible to obtain these sound or image files in the alarm-clock via the integrated “WIFI”® or “WIMAX”® link but, in such a case, the exchanges instead of being performed via the telephone network, will take place over a data link, in particular over the Internet.

According to a preferred variation, the alarm-clock includes at least one master USB® input-output whereon any USB® compatible device can be connected, in particular memory, a “BLUETOOTH”® radio-communicating module, baffles, one/several sensors (temperature . . . ), a video camera (deviation towards the image network for telesurveillance) or the like. Such a USB® connector enables easy initial configuration of the alarm-clock for its first implementation. Indeed, in order to be able to communicate with other pieces of equipment and in particular the computer programming device, the telephone must be recognised and the data exchange protocols made compatible (in particular as regards the encryption keys). Configuration data must hence be input in the alarm-clock and if the user interface of the alarm-clock so enables, it is usually cumbersome since said interface is very limited (neither digital nor alphanumeric keypad and even less AZERTY or QWERTY keyboard). The system hence includes means enabling to unload in the alarm-clock the configuration data of the alarm-clock from of a USB memory dongle in advance loaded with said configuration data. This USB memory dongle could have been loaded by the programming device or by another appropriate piece of equipment (for instance “FREEBOX”® or “LIVEBOX®” gateway). This initial configuration of the alarm-clock is necessary only once in a given communication environment. The USB interface of the alarm-clock may also be an alternative means (to those provided by the radio means or by carrier currents) for software updating the alarm-clock via a USB memory dongle.

The other interfaces in particular for outputting (visual restitution via a display monitor of at least of the time) or for inputting (simplified keyboard with a reduced number of keys) have not been represented to simplify FIG. 1. The term time display means the display of the hours properly speaking as well as of the minutes, possibly the seconds, of the current time, of the alarm (possible other actions triggering times or actions stopping times, see triggered time-delay).

Preferably, the alarm-clock includes at output a display monitor (and software means) enabling the visualisation of static or dynamic images and, besides, at input a microphone (not represented on FIG. 1) enabling to input voice commands, whereas the voice recognition is performed remotely, away from the alarm-clock, in particular in a network-based server and sending-back instructions towards the alarm-clock. The possibility of sounds transmission from the alarm-clock to the outside, in particular by “WIFI®” or “WIMAX®” or “BLUETOOTH®” link or carrier currents enables bidirectional voice communications. The alarm-clock of the invention may thus be used as an interphone or for sound surveillance (surveillance of a toddler: <<babyphone>>).

Thus, according to its version, the system with the alarm-clock of the invention may enable the restitution either of the sound files only (the display is reduced to its easiest expression for hours), or image files only (fixed and/or video), or of both with or without possibility of streaming as the case may be. The system also enables, in the other communication direction, to send back user selections towards the programming device (in practice a distant server over the web network, a gateway enabling to relay the communications between the server and the alarm-clock) so as to enable interactions between the different elements of the system and to increase the apparent capacities of the alarm-clock while conducting certain tasks or storing data remotely from the alarm-clock (in particular in a distant server over the web network). Thus, the exchanges between the alarm-clock and the outside (telephone, local or remote PC/server, residential multimedia terminal) are preferably bidirectional (in particular <<PUSH>> and <<PULL>> operations in the case of “BLUETOOTH”®).

On FIG. 1, the computer programming device 2 is here a local PC computer with a RS232 serial interface 9 connected to a communication dongle (module) 8 “BLUETOOTH”® (<<dongle>> “BLUETOOTH” from BARACODA company). It should be understood that in case when the alarm-clock and/or the computer programming device posses a USB interface, the communication dongle (module) 8 “BLUETOOTH”® can be connected to this USB interface. The other interfaces whereof display monitor, data input keyboard, data exchange (telephone or cable in particular for Internet) have not been represented to simplify Figure. On FIG. 1 the web link between the PC 2 and a website (<<WEB>>) is symbolised in the same frame which also includes the WEB communication interface and the alarm-clock communication application with their respective exchange channels RS232 and TCP/IP as well for the execution of the console application.

More generally speaking, the computer programming device 2 may be local (as represented) as well as remote. In the latter case, the programming device 2 is a web network server and a local gateway to the alarm-clock is implemented, in particular such as a terminal residential box of telephone or of data (ADLS) cable as for example a “FREEBOX”® or “LIVEBOX”®.

The alarm-clock device of the system of the invention is thus an apparatus capable of restituting multimedia files, sound files in MP3 format or others and the streaming in web radio broadcast mode and/or short text format such as SMS or MMS and including “WIFI”® or “WIMAX”® linking means and, possibly, “BLUETOOTH”®, to provide the user with the possibility of downloading from his PC (or any other device as a telephone or an electronic assistant) or via a gateway new dialling tones, music files, images and SMS/MMS messages on his alarm-clock. It should be understood that the term multimedia file covers any type of data, sounds, images, texts (SMS or others) possibly programs to run in the alarm-clock (for instance for updating the software of the alarm-clock or for downloading a game on the alarm-clock).

The alarm-clock is a simplified computer device which differentiates it from a personal computer and even from a device such as a radio-communicating personal assistant. Its own calculation and memorization capacities are limited and a portion of the operations necessary to its operation is performed remotely, in particular in a remote server. It is the case of the recognition of the vocal commands (or, in some cases, sounds or images restituted to determine what the user is listening to or viewing), wherein the alarm-clock transmits the sounds picked up by the microphone of the alarm-clock towards the remote server where they are analyzed, the determined command and the corresponding instruction returned to the alarm-clock for execution if the latter should be done in the alarm-clock. In other cases, for instance voice selection of a multimedia file, the command is run in the server and it is the file selected which is returned to the alarm-clock. A portion of the management being performed remotely from the alarm-clock, in a programming device with large capacities (a server in practice, a gateway local to the alarm-clock being implemented), it is possible to offer numerous services to the user. For instance, it is possible to keep in memory in the server the location where the user (or a particular user of the alarm-clock in case when several users might employ the same alarm-clock) has stopped listening/reading/visualizing a multimedia content.

Similarly, so as to obtain a reduced latent time further to a command, in particular for the selection of a multimedia content, the selections are performed along hierarchy-arranged menus (tree-structures) for which the alarm-clock is transmitted and given to store only a small amount of data corresponding to the current level of the selection Ni and to those, only, of the level immediately following Nᵢ₊₁ (toward the end of the branches of the tree-structure) of the hierarchy of the menu. This has been represented on FIG. 2 where the framed menu level data Ni (current level) and Nᵢ₊₁ (next level) are stored in the alarm-clock, the other levels remaining available in the server. On FIG. 2 each branch end of a menu includes an address (url) or a list of addresses which is only a small portion of all that is available and it should be understood that the amount of data which the alarm-clock must store is reduced. This operating mode therefore opposes the case where all the data of the menu, in practice the network addresses (url) of the files which may be brought back towards the alarm-clock, are transmitted and must be stored in the alarm-clock. On the other hand, the use of a hierarchy-based menu simplifies the research a file user since the menu is conceptual contrary to a list of network addresses (url) among which he must choose. An example of hierarchical conceptual menu is for instance based upon the type of music (jazz vs pop vs classical . . . ) wherein the sub-menus corresponding to each are based upon another level of conceptualisation (for instance for the classical sub-menu: romantic vs polyphonic vs . . . ). However, for easier selection, a first menu (uppermost) provides a choice between preferred versus selected so enable quicker access to the preferred files.

Thus, placing into a local cache (memory), in the alarm-clock, the next level of the current selection level in the menu hierarchy enables to maximise the memory occupation and the use of the radio communications passband and/or telephone network and/or Internet. According to a variation, it is also possible to keep in the cache (memory) of the alarm-clock the level immediately preceding of the current selection level in case when the user would choose to scroll up in the menu hierarchy instead of scrolling down towards the final network address (url) where the multimedia file of his choice can be found. Thus, in addition to the current Ni and next Nᵢ₊₁ levels, one keeps in the cache memory the preceding Nᵢ₋₁ level, the scrolling in the hierarchy of the menu thereby overwriting the levels according to the scrolling direction in the menu. Thus, the system enables dynamic management of the memorization of the tree-structure of the menus in the alarm-clock enabling memory and passband savings.

Still in order to maximize the operation of the multimedia radio alarm-clock and more particularly reduce the latent time between the time when the file to be restituted has been selected (the url address found and the corresponding site contacted) and the beginning of the restitution of the file (in particular sound or video), the size threshold of the temporary storage buffer-memory of the file in the multimedia radio alarm-clock from which the restitution starts (a minimum amount of data to be restituted should be available in the buffer memory for the restitution to start, such minimum corresponds to this threshold) is managed dynamically and is modified according to various criteria. A first criterion is a reduced latent time which implies that the threshold is reduced at the beginning of the restitution then increased at a later stage once the restitution has started. A second criterion is associated with the quality of the site wherein the file is located, in particular in terms of passband, the smaller the passband the higher the threshold. Thus for a high passband site the value of the threshold is reduced (amount of data/memory size) relative to a site with less good a passband. Quality can be measured in real time and/or, preferably, the server or the multimedia radio alarm-clock keeps in memory a quality index of the sites already looked up and uses such index to calculate the threshold. Thus, the size of the buffer-memory (buffer) of the multimedia radio alarm-clock adapts in real time. In particular, during the first connection toward an Internet radio station (selected url site), the radio plays when the filling level of the buffer reaches a certain size value. This size is then increased to reach its rated size. It is also possible to add a score on each radio. If the quality of a radio is bad, the size will be greater than for a good quality radio having a good passband. This enables to provide shorter access time for loading a new radio.

If the previous example, in relation to FIG. 2, relates to music, it should be understood that the invention is applicable to any type of multimedia content which can be restituted by the alarm-clock as for instance books/electronic comics (display restitution) or spoken books (sound restitution, for instance a cooking recipe) or videos.

The system of the invention, also enables, thanks to the programming device, in particular in case when the latter is a server dedicated to the management of the alarm-clocks of different users, following up on users choices, marketing multimedia contents, and more generally all the operations conventionally available over the web network or conventional telephone network. Choice follow-up may take place directly at the server according to how well the latter knows the network address selected by the user for the selection of a multimedia file. However, the alarm-clock can be set up for selecting contents from several independent servers or from other sources (web or telephone) and the users' choices are then followed up by transmission from the alarm-clock of a reduced portion (a few seconds in the case of sounds, a portion of image in the case of images/video or an image in the case of a video) of the file restituted, towards the server and comparison in the server with a local database (or remotely by accessing other addresses) of the files which can be restituted. In the latter case, if no recognition is possible, a limited iterative process can be implemented with another portion of file from the alarm-clock.

Following up on users choices, in addition to offering to buy the musical item, the book, the picture or video thus corresponding, may enable more accurate targeting of written/filmed advertising which can be sent systematically to the display monitor of the alarm-clock or sound advertising which is broadcast systematically by the loudspeaker(s) of the alarm-clock according to a time-schedule that the broadcaster may select or in automated response to the user's choice. The broadcaster may, for instance, as regards sound advertising also select the conditions of restitution, in particular the sound level which will be preferably reduced for broadcasting in the middle of the night.

Alternately to broadcaster-initiated advertising, the user of the alarm-clock may elect to be notified of particular events by an alarm, sound or visual restitution on its alarm-clock.

The system of the invention, alarm-clock and programming device (local or remote), hence includes means enabling to meet one or several of the objectives which are described in the present application.

Preferably, the electronic means of the alarm-clock are reduced to a minimum and a single main computer chip is implemented which includes the radio interface circuitry, USB, carrier currents, display, sound restitution, acquisition of choices/sounds with the corresponding programmed (re-programmable) hardware and software means. Similarly, preferably, the chip enables the management of the intellectual property rights on the multimedia contents.

The alarm-clock device can be in two modes, a stand-alone or non-connected mode wherein there is no radioelectric communication and wherein it appears to function like a standard alarm-clock and a connected mode.

The alarm-clock device includes means enabling to perform the main following functions:

Time and SMS display which is activated if no other specific function is launched. The time and the SMS are then displayed on the display of the alarm-clock. The first twenty characters of the SMS are displayed, then the SMS scrolls character per character while being deported from right to left.

A bell qui is activated when current time is equivalent to the time of the bell. The bell consists in playing the piece of music selected. The music stops when a person depresses any key.

MP3 download when the device computer programming device, here the computer, sends a music download command via the “WIFI”® or “WIMAX”® or RS232+“BLUETOOTH”® link. The piece of music is then received over the “WIFI”® or “WIMAX”® or RS232+“BLUETOOTH”® link of the alarm-clock device. A sign (letter “T” top-right on the display) is displayed on the display of the alarm-clock during download. Enables to record in the alarm-clock the MP3 music file sent.

Synchronising the time when the user depresses a first key of the alarm-clock device when the current time of the alarm-clock is displayed. When turning on the alarm-clock, the time is synchronised automatically. To do so, the alarm-clock device will search for the time of the PC over the “WIFI”® or “WIMAX”® or RS232+“BLUETOOTH”® link. A sign (letter “S” top-right on the display) is displayed on the display of the alarm-clock when synchronising the time. After performing such function, the alarm-clock displays the same time as the PC.

Setting the time when the user depresses a second key of the alarm-clock device when the current time of the alarm-clock is displayed. In this view, a display asks for the new time, the user inputs the new time with the digital keys then the user depresses the second key. Afterwards, the alarm-clock displays the new time.

Setting the ring bell time when the user depresses a third key when the current time of the alarm-clock is displayed. To do so, a request for new time of the bell is displayed, the user inputs the new time of the ring bell with the digital keys then the user depresses the third key.

Activation/de-activation of the ring bell when the user depresses a fourth key when the current time of the alarm-clock is displayed. If the bell is activated then it is de-activated and a luminous spot in the lower left section of the display unit disappears and if the bell is de-activated then it is activated and the luminous spot in the lower left section of comes on.

SMS suppression when the user depresses a fifth key when the current time of the alarm-clock is displayed. It follows that the SMS is not displayed any longer.

Reception of the commands form the PC when the PC sends commands to the alarm-clock, in particular sending SMS from the PC towards the alarm-clock, asking for reading the configuration of the alarm-clock for return to the PC or writing configuration from the PC towards the alarm-clock. In this view, the alarm-clock receives the commands and performs them.

As regards the computer programming device (PC in local mode or a remote server via accessing a website) or via a residential gateway (PC/remote server on a website for compatible functions) the following functions are also considered on said computer programming device called generically PC here:

synchronising of the time when the alarm-clock emits a time synchronisation request on the “WIFI”® or “WIMAX”® or RS232+“BLUETOOTH”® link. To do so, the alarm-clock communication application of the PC receives a synchronisation request on the “WIFI”® or “WIMAX”® or RS232+“BLUETOOTH”® link. The application sends in response the time on the “WIFI”® or “WIMAX”® or RS232+“BLUETOOTH”® link. It follows that current time of the alarm-clock must be synchronised with the time of the PC. In this view, the alarm-clock communication of the PC must be launched and in permanent listening mode on the “WIFI”® or “WIMAX”® or RS232+“BLUETOOTH”® link.

Modification of the configuration of the alarm-clock when the user accesses the configuration application (example on a website or <<Java applet>> on a telephone) of the configuration of the alarm-clock in order to modify the configuration. To do so, the user opens the home page of the configuration application of the alarm-clock, the user clicks on a link entitled “modify the configuration of the alarm-clock” and the configuration application launches the communication interface to read the configuration of the alarm-clock. The communication interface then emits a read command of the configuration of the alarm-clock toward the alarm-clock communication application via the network link TCP/IP. The alarm-clock communication application transfers the command to the alarm-clock via the “WIFI”® or “WIMAX”® or RS232+“BLUETOOTH”® link. The alarm-clock returns in response its current configuration via the “WIFI”® or “WIMAX”® or RS232+“BLUETOOTH”® link. The alarm-clock communication application transfers the reply to the communication interface. The communication interface transfers the reply to the configuration application. The configuration of the alarm-clock is displayed in the navigator of the user (in particular activation or not of the bell, time of the bell, current time displayed, titles of the MP3 downloaded . . . ).

At that time, either the user does not modify anything and returns to the home page, or he does modify the editable fields (for instance activation or de-activation of the bell, time of the bell, current time displayed) and clicks on the button “Modify” and the configuration application launches the communication interface to write the configuration of the alarm-clock, whereby the communication interface emits a write command of the configuration of the alarm-clock toward the alarm-clock communication application via the network link TCP/IP, then the alarm-clock communication application transfers the command to the alarm-clock via the “WIFI”® or “WIMAX”® or RS232+“BLUETOOTH”® link, and the alarm-clock returns an acknowledgement over the “WIFI”® or “WIMAX”® or RS232+“BLUETOOTH”® link, the alarm-clock communication application transfers the reply to the communication interface and the communication interface transfers the reply to the configuration application. In the latter case, the configuration of the alarm-clock is modified.

To perform these operations, the alarm-clock must be switched on, the alarm-clock communication of the PC must be launched and in permanent listening mode on the network link which might be TCP/IP (Internet) or the like.

Download sound and fixed or moving image files in different formats when the user accesses the configuration application of the alarm-clock for downloading sound or video files into the alarm-clock. In this view, the user opens the home page of the configuration application of the alarm-clock and clicks on the link “Download files” then the user clicks on the button “Scroll . . . ” for selecting a file to download onto his hard drive. The user may modify, if he so wishes, the title offered automatically and clicks on the button “Download”. At that time, the website (<<WEB>>) launches the communication interface for downloading the file and the communication interface emits a download command of the files toward the alarm-clock communication application via the network link TCP/IP. Then, the alarm-clock communication application transfers the command to the alarm-clock via the “WIFI”® or “WIMAX”® or RS232+“BLUETOOTH”® link, and the alarm-clock returns in response an acknowledgement over the “WIFI”® or “WIMAX”® or RS232+“BLUETOOTH”® link. The alarm-clock communication application transfers the reply to the communication interface which transfers the reply to the configuration application. The result of the download is displayed in the navigator of the user and the latter clicks either on the return to home page button, or on the button for downloading other files to start the function again according to the operations listed above. It follows that the new music is available on the alarm-clock.

To perform these operations, the alarm-clock must be switched on and the alarm-clock communication application of the PC must be launched and in permanent listening mode on the network link TCP/IP. Preferably, the download time ranges between 5 and 10 seconds maximum and several music files may be downloaded and it must be possible to overwrite an older file from the alarm-clock device.

Download SMS messages when the user accesses the configuration application of the alarm-clock for downloading SMS messages into the alarm-clock. In this view, the user opens the home page of the configuration application of the alarm-clock and clicks on the link “Download SMS”. The user then writes the SMS to download in the SMS field displayed in the navigator. He specifies his name or his telephone number in the sender field. He modifies if he wishes the dispatch date. Then, the user clicks on the button “Download” and the configuration application launches the communication interface to download the SMS. The communication interface emits an SMS download command toward the alarm-clock communication application via the network link TCP/IP. The alarm-clock communication application transfers the command to the alarm-clock via the “WIFI”® or “WIMAX”® or RS232+“BLUETOOTH”® link, and the alarm-clock returns in response an acknowledgement over the “WIFI”® or “WIMAX”® or RS232+“BLUETOOTH”® link. The alarm-clock communication application transfers the reply to the WEB communication interface then the communication interface transfers the reply to the configuration application. The result of the download is displayed in the navigator of the user. It follows that the new SMS scrolls on the display of the alarm-clock.

To perform these operations, the alarm-clock must be switched on and the alarm-clock communication application of the PC must be launched and in permanent listening mode on the network link TCP/IP. Preferably, the download time of the SMS must be ranging between 5 and 10 seconds maximum for a SMS text limited to 150 characters. The dispatch date is pre-filled in.

MP3 download with SMS (<<push function>>) when the user accesses the configuration application of the alarm-clock for downloading a file and an SMS in a single operation into the alarm-clock (for instance to wish a happy birthday or warn of any alert). In this view, the user opens the home page of the configuration application of the alarm-clock and clicks on the link “Download MP3 with SMS”. The user then clicks on the button “Scroll . . . ” for selecting a file to download onto his hard drive. The user may modify, if he so wishes, the title offered automatically. The user writes the SMS to download in the SMS field displayed in the navigator and he specifies his name or his phone number in the sender field. He may modify, if he wishes, the dispatch date. Finally, the user clicks on the button “Download”. The configuration application launches the communication interface to download the MP3 and the SMS, and the communication interface emits an MP3 and SMS download command toward the alarm-clock communication application via the network link TCP/IP. The alarm-clock communication application transmits an MP3 download command to the alarm-clock via the “WIFI”® or “WIMAX”® or MP3+“BLUETOOTH”® link, and the alarm-clock returns in response an acknowledgement over the “WIFI”® or “WIMAX”® or RS232+“BLUETOOTH”® link. The alarm-clock communication application transmits an SMS download command to the alarm-clock via the “WIFI”® or “WIMAX”® or MP3+“BLUETOOTH”® link, and the alarm-clock returns in response an acknowledgement over the “WIFI”® or “WIMAX”® or RS232+“BLUETOOTH”® link. The alarm-clock communication application transmits the replies to the communication interface and the communication interface transfers the replies to the configuration application. The result of the download is displayed in the navigator of the user. The user may then, either click on the return to home page button, or on the button for downloading another MP3 file with SMS to start the function again according to the operations listed above. The result is then that a new sound file is available on the alarm-clock as well the new SMS which scrolls on the display of the alarm-clock. In relation to of parameters also transmitted, the SMS and the music will be displayed immediately or transfers at the time where the alarm-clock is programmed for the alarm.

To perform these operations, the alarm-clock must be switched on and the alarm-clock communication application of the PC must be launched and in permanent listening mode on the network link TCP/IP. Preferably, the download time should be ranging between 5 and 10 seconds maximum and a single MP3 music file maximum may be downloaded with the possibility of overwriting an older file from the alarm-clock.

Preferably, the text of the SMS limited to 150 characters and the dispatch date is pre-filled in.

The alarm-clock device includes sufficient memory for approximately ten bells/MP3 files maximum downloaded with possibility of replacing (overwriting) files and a maximum of approximately five SMS downloaded with also possibility of replacement Synchronising the time is automatic after each power cut of the alarm-clock and loss of the current time.

The computer programming device is a PC/server type communication platform with “Windows2000/XP”® or a “FREEBOX”®, “LIVEBOX”® type gateway, fitted with a “WIFI”® or “WIMAX”® or “BLUETOOTH”® communication module with the alarm-clock device.

The protocol of the system regarding more particularly the “WIFI”® or “WIMAX”® or RS232+“BLUETOOTH”® link between the alarm-clock device and the programming computer device will now be described in its main features by using a program presentation language. To do so a notation given in Table I is used:

TABLE I
Notation

| Symbol | Meaning- |
|---|---|
| = | Is formed of: |
| \| | or |
| & | and (in the description order) |
| a | Container (structure or union in C language) |
| [a, b, c] | List of atomic elements (fields of a C language structure) |

The high level containers are:
MartinProtocol = NotififyPacket | Packet
Packet = Header & Data
Data = MP3 | SMS | ConfigRequest | Config |
TimeRequest | Time | Status | Ack
MP3 = MP3Header | MP3Data
The low level containers are:
NotifyPacket = [Type]
Header = [Tag, Version, Type, CRC8]
MP3Header = [MP3StoreNumber, MP3Title, MP3Size]
MP3Data = [IsLastMP3Packet, MP3PacketSize, MP3PacketData]
SMS = [SMSSize, SMSText]
Config = [TimeValue, IsAlarmOn, AlarmTimeValue, MP3StoresCount,
MP3StoreSelected, MP3Titles]
ConfigRequest = [ ]
Time = [TimeValue]
TimeRequest = [ ]
Status = [StatusValue]
Ack = [AckValue]

The atomic elements are given in Table 11:

TABLE II
Atomic elements

| | | | Size in |
|---|---|---|---|
| Atom | Description | Type | bytes |
| AckValue | Acknowledgement value: | Integer | 1 |
| | 0x00 = negative | positive | |
| | 0x01 = positive | | |
| AlarmTimeValue | Time at which the bell of the alarm-clock | Binary | 2 |
| | is triggered | | |
| | The first byte contains the number of | | |
| | hours, it is a positive integer ranging | | |
| | between 0 and 23. | | |
| | The second byte contains the number of | | |
| | minutes, it is a positive integer ranging | | |
| | between 0 and 59. | | |
| CRC8 | Result of the checksum calculation | Positive | 1 |
| | CRC8 on the data container. The values | integer | |
| | range between 0x00 and 0xFF | | |
| IsAlarmOn | Specifies whether the bell of the alarm- | Positive | 1 |
| | clock is activated. | integer | |
| | 0x00 = bell de-activated | | |
| | 0x01 = bell activated | | |
| IsLastMP3Packet | Specifies whether the MP3 data | Positive | 1 |
| | container is the lasts one. | integer | |
| | 0x00 = Other containers will follow | | |
| | 0x01 = Last container | | |
| MP3PacketSize | Size of the useful data in the associated | Strictly | 2 |
| | MP3PacketData atom. | positive | |
| | The integer value is “Big Endian” | integer | |
| | encoded and ranges between 1 and | | |
| | 500. If the associated IsLastMP3Packet | | |
| | atom is equal to 0x00, then the value of | | |
| | MP3PacketSize must be equal to 500 | | |
| MP3PacketData | MP3 data | Binary | 500 |
| MP3Size | Total size of the downloaded MP3 file. | Strictly | 4 |
| | The integer value is “Big Endian” | positive | |
| | encoded. | integer | |
| MP3StoresCount | Number of MP3 files downloaded in the | Positive | 1 |
| | alarm-clock. | integer | |
| | The integer value ranges between 0 | | |
| | and 10. | | |
| MP3StoreSelected | Number of the MP3 file downloaded | Strictly | 1 |
| | selected for the bell of the alarm-clock. | positive | |
| | The integer value ranges between 1 | integer | |
| | and 10. | | |
| MP3StoreNumber | Number of the downloaded MP3 file to | Strictly | 1 |
| | be replaced with the new MP3 file being | positive | |
| | downloaded | integer | |
| | The integer value ranges between 1 | | |
| | and 10. | | |
| MP3Title | Title of the downloaded MP3 file | ASCII | 20 |
| | displayed on the alarm-clock. | | |
| | If the title is shorter than 20 bytes, it will | | |
| | be offset to the right with spaces. | | |
| MP3Titles | List of the titles of the 10 MP3 files | ASCII | 200 |
| | downloaded on the alarm-clock. The list | | |
| | starts with the 20 characters of the title | | |
| | n°1 then the 20 characters of the title | | |
| | n°2 and so on up to the 20 characters of | | |
| | the title n°10. | | |
| | If a title is shorter than 20 bytes, it is | | |
| | offset to the right with spaces over 20 | | |
| | bytes. | | |
| | If a location is empty, the title is | | |
| | replaced with 20 spaces. | | |
| SMSSize | Size of the useful data in the associated | Strictly | 1 |
| | SMSText atom. The value ranges | positive | |
| | between 1 and 255. | integer | |
| SMSText | SMS text offset to the right with spaces. | ASCII | 255 |
| StatusValue | Status value in response to a packet | Positive | 1 |
| | notification from the PC. | integer | |
| | 0x00 Alarm-clock unavailable | | |
| | 0x01 Alarm-clock ready to receive the | | |
| | packet specified in the Type associated | | |
| | atom | | |
| Tag | Protocol tag = MARTIN | ASCII | 6 |
| TimeValue | Time displayed on the alarm-clock. | Binary | 2 |
| | The first byte contains the number of | | |
| | hours, it is a positive integer ranging | | |
| | between 0 and 23. | | |
| | The second byte contains the number of | | |
| | minutes, it is a positive integer ranging | | |
| | between 0 and 59. | | |
| Type | Type of the packet received or sent by the alarm- | Positive | 1 |
| | clock | integer | |
| | 0x01 = MP3(MP3Header) | | |
| | 0x02 = MP3(MP3Data) | | |
| | 0x03 = SMS | | |
| | 0x04 = ConfigRequest | | |
| | 0x05 = Config | | |
| | 0x06 = TimeRequest | | |
| | 0x07 = Time | | |
| | 0x08 = Status | | |
| | 0x09 = Ack | | |
| Version, | Protocol version = 0x01 | Positive | 1 |
| | | integer | |

We shall now detail the sequences of the protocol in the form of diagrams. By reason of simplified explanations, these sequences are here considered as streamings carried out successfully. Conversely, in reality, upon reception of an unavailable status or of a negative acknowledgement, the stream of the sequences stops immediately. Additionally, more generally speaking, any sequence is stopped if a timeout exceeds approximately 30 seconds between two streams. The alarm-clock device is denominated alarm-clock and the computer programming device is here a PC.

### For Time Synchronisation

### Alarm-clock--------Packet(TimeRequest)--------------->PC

### Alarm-clock<------Packet(Time)--------------------------PC

### Alarm-clock--------Packet(Ack)-------------------------->PC

### MP3 Download

### PC------NotifyPacket(MP3Header)--------->Alarm-clock

### PC<------Packet(Status)-------------------------Alarm-clock

### PC--------Packet(MP3Header)----------------->Alarm-clock

### PC<------Packet(Ack)---------------------------Alarm-clock

### PC--------Packet(MP3Data)-------------------->Alarm-clock

PC<------Packet(Ack)---------------------------Alarm-clock ( . . . ) repeated as often as necessary

### PC--------Packet(MP3Data)-------------------->Alarm-clock

### PC<------Packet(Ack)---------------------------Alarm-clock

### SMS Download

### PC--------NotifyPacket(SMS)----------------->Alarm-clock

### PC<------Packet(Status)-------------------------Alarm-clock

### PC--------Packet(SMS)-------------------------->Alarm-clock

### PC<------Packet(Ack)------------------------------Alarm-clock

### Reading Configuration

### PC--------NotifyPacket(ConfigRequest)------>Alarm-clock

### PC<------Packet(Status)---------------------------Alarm-clock

### PC--------Packet(ConfigRequest)------------->Alarm-clock

### PC<------Packet(Config)---------------------------Alarm-clock

### PC--------Packet(Ack)---------------------------->Alarm-clock

### Writing Configuration

### PC--------NotifyPacket(Config)---------------->Alarm-clock

### PC<------Packet(Status)---------------------------Alarm-clock

### PC--------Packet(Config)--------------------------->Alarm-clock

### PC<------Packet(Ack)---------------------------Alarm-clock

It should be understood that the examples given are illustrative and that the connection on a network specified as being Internet may within the framework of the invention concerns any type of computer network as for example INTRANET or private, possibly a GSM telephone network or the extensions thereof enabling data exchanges. Similarly, securing data exchanges has not been detailed over the communication link as well as over the network when accessing a website but, in enhanced versions of the invention, such means will be implemented in particular to guarantee the rights of the multimedia producers, of the web manager and/or to prevent third parties from disturbing the operation of the system by reprogramming it. Additionally, the example shows two distinct entities, the alarm-clock device and the computer programming device, connected by radiofrequency communication link or carrier currents but in a variation, both these devices may be arranged in the same structure (box) and the communication link will then be of serial wire type between both, in particular in the case of a gateway (multimedia router). Finally, the alarm-clock has been described as a particular hardware device but the invention also covers the case where the alarm-clock is virtual and is simulated on a radio-communicating computer means as for example a personal computer or personal assistant.

1. A computer multimedia radio alarm-clock system with a communication link between on the one hand a multimedia radio alarm-clock device (1) and on the other hand a distinct computer programming device (2) characterised in that it comprises a short distance bi-directional local communication link (3,8) enabling to make the multimedia radio alarm-clock device and the computer programming device communicate with one another, wherein the multimedia radio alarm-clock device includes:
a reproduction interface, at least visual and acoustic,
an input interface of at least user selections,
a local communication link interface “WIFI”® or ‘WIMAX’®,
a local communication link interface by mains carrier currents,
a USB® interface,
means enabling reception, storage and reproduction, continuously or not, of multimedia messages, in particular sound and/or texts and/or images and/or video data,
means enabling to set up the operation of said alarm-clock either directly by inputting configuration data via the input interface of said alarm-clock, or by receiving configuration data via the local communication link, or by unloading onto the USB® interface configuration data from a USB® compatible memory, and in that the system includes means enabling to perform in the computer programming device tasks in relation with the activity of the alarm-clock.

2. A system according to claim 1, characterised in that the multimedia radio alarm-clock device includes moreover a sound input and acquisition interface for voice selections by a user, and that the sounds once acquired are transmitted to the computer programming device for performing a voice recognition task of selections.

3. A system according to claim 1, characterised in that the selections are performed from menus and in that the menus are arranged in a level-based tree-structure, wherein the menus are stored in the computer programming device, and in that the system includes means so that during the selections in the multimedia radio alarm-clock device, the current level of the selection Ni and the level immediately following Nᵢ₊₁ of the hierarchy of the menu are stored in the multimedia radio alarm-clock device.

4. A system according to claim 3, characterised in that the system includes means for storing in the multimedia radio alarm-clock device moreover the level immediately preceding Nᵢ₋₁ of the current level Ni of the hierarchy of the menu.

5. A system according to claim 1, characterised in that the computer programming device is distant and is on a web network and in that it includes a communication application with the alarm-clock device via a gateway, wherein a web communication interface enables to perform a console application of an alarm-clock configuration website.

6. A system according to claim 1, characterised in that the multimedia radio alarm-clock device includes moreover an RS232 interface.

7. A system according to claim 1, characterised in that the multimedia radio alarm-clock device includes moreover a ‘BLUETOOTH’® local communication link interface.

8. A system according to claim 6, characterised in that the ‘BLUETOOTH’® local communication link interface is transferred to a ‘BLUETOOTH’® interface dongle connected to the USB® or RS232 interface of the multimedia radio alarm-clock device.

9. A system according to claim 1, characterised in that it comprises means enabling to know the multimedia data reproduced by the multimedia radio alarm-clock device, wherein one of the means is the transmission from the multimedia alarm-clock radio device towards the computer programming device of a portion of the data reproduced and comparison in said computer programming device with a reproducible database.

10. A system according to claim 1, characterised in that for reproducing a multimedia message, a file is downloaded in a buffer-memory of the multimedia alarm-clock radio device, the restitution starting when a filling threshold of the buffer-memory has been reached, and in that the system includes means enabling to modify the threshold in relation to criteria, said criteria being selected among one or several of the following criteria:
duration of the latent time before the beginning of the restitution, wherein the reduction of said latent time is obtained by reducing the threshold,
quality of the download in terms of passband, wherein a high passband causes reduction of the threshold.

11. A multimedia radio alarm-clock device especially adapted for the system of claim 1 any of the previous claims.

12. A system according to claim 2, characterised in that the selections are performed from menus and in that the menus are arranged in a level-based tree-structure, wherein the menus are stored in the computer programming device, and in that the system includes means so that during the selections in the multimedia radio alarm-clock device, the current level of the selection Ni and the level immediately following Nᵢ₊₁ of the hierarchy of the menu are stored in the multimedia radio alarm-clock device.

13. A system according to claim 2, characterised in that the computer programming device is distant and is on a web network and in that it includes a communication application with the alarm-clock device via a gateway, wherein a web communication interface enables to perform a console application of an alarm-clock configuration website.

14. A system according to claim 2, characterised in that the multimedia radio alarm-clock device includes moreover an RS232 interface.

15. A system according to claim 2, characterised in that the multimedia radio alarm-clock device includes moreover a ‘BLUETOOTH’® local communication link interface.

16. A system according to claim 2, characterised in that the ‘BLUETOOTH’® local communication link interface is transferred to a ‘BLUETOOTH’® interface dongle connected to the USB® or RS232 interface of the multimedia radio alarm-clock device.

17. A system according to claim 2, characterised in that it comprises means enabling to know the multimedia data reproduced by the multimedia radio alarm-clock device, wherein one of the means is the transmission from the multimedia alarm-clock radio device towards the computer programming device of a portion of the data reproduced and comparison in said computer programming device with a reproducible database.

18. A system according to claim 2, characterised in that for reproducing a multimedia message, a file is downloaded in a buffer-memory of the multimedia alarm-clock radio device, the restitution starting when a filling threshold of the buffer-memory has been reached, and in that the system includes means enabling to modify the threshold in relation to criteria, said criteria being selected among one or several of the following criteria:
duration of the latent time before the beginning of the restitution, wherein the reduction of said latent time is obtained by reducing the threshold,
quality of the download in terms of passband, wherein a high passband causes reduction of the threshold.
